(19) United States
(12) Patent Application Publication
(10) Pub. No.: US 2022/0268913 A1
(43) Pub. Date: Aug. 25, 2022

(54) GAS SPRING SENSORS USING MILLIMETER WAVELENGTH RADAR AND GAS SPRING ASSEMBLIES AND SUSPENSION SYSTEMS INCLUDING SAME

(71) Applicant: Firestone Industrial Products Company, LLC, Nashville, TN (US)

(72) Inventor: Daniel L. Nordmeyer, Largo, FL (US)

(21) Appl. No.: 17/627,384

(22) PCT Filed: Jul. 15, 2020
(86) PCT No.: PCT/US2020/042038

§ 371 Date: Jan. 14, 2022

Related U.S. Application Data
(60) Provisional application No. 62/874,323, filed on Jul. 15, 2019.

(51) Int. Cl. G01S 13/32; B60G 11/27; F16F 9/04; F16F 9/32

(52) U.S. Cl. CPC G01S 13/32; B60G 11/27; F16F 9/0472; F16F 9/3292; B60G 2202/152; B60G 2204/111; B60G 2400/202; B60G 2400/25; B60G 2401/174

(57) ABSTRACT

Gas spring sensors including a millimeter wave radar source and a target surface disposed in spaced relation to the radar source. The sensors also include a millimeter wave radar receptor operable to generate a signal upon receiving the radar waves reflected off the target surface. The radar source is operable to direct millimeter-length radar waves of a frequency greater than or equal to 120 gigahertz (GHz) and a wavelength of 2.5 millimeters or less toward the target surface. A processor is communicatively coupled with the radar source and the radar receptor, and is operable to determine a displacement and a relative velocity using pulsed Doppler or continuous wave frequency modulation radar methods that rely on time of flight and frequency phase shifts of pulsed or continuous radar waves. Gas spring assemblies including such sensors, and suspension systems including one or more of such gas spring assemblies are also included.

### BACKGROUND

The subject matter of the present disclosure broadly relates to the art of pneumatic devices such as gas spring assemblies that include internal sensors operative to generate signals, data and/or other outputs having a relation to displacement (also referred to as “height” or “distance”), velocity, and/or acceleration associated with the gas spring assemblies using millimeter wave radar technology of an predetermined frequency and wavelength and/or within a predetermined range of frequencies and wavelengths. Gas spring assemblies including such millimeter wave radar sensors as well as suspension systems and/or vehicle systems including one or more of such gas spring assemblies are also included.

It will be appreciated that the subject sensors, as well as the gas spring assemblies and suspension system that include one or more of such sensors, are amenable to broad use in a wide variety of applications and environments. As examples, suitable applications and/or uses can include vehicle suspension systems, cab mounting arrangements and seat suspensions such as may exist over-the-road trucks and tractors, rail vehicles, agricultural vehicles, industrial vehicles, as well as in other machinery having moving or vibrating parts. It will be appreciated that the subject matter of the present disclosure may be particularly amenable to use in connection with motorized vehicles and will be discussed in detail hereinafter with specific reference thereto. However, it is to be specifically understood that the subject, as well as the gas spring assemblies and/or suspension systems that include one or more of such sensors, are not intended to be in any way limited to the specific examples of suitable applications disclosed herein, which are merely exemplary.

Wheeled motor vehicles of most types and kinds include a sprung mass, such as a body or chassis, for example, and an unsprung mass, such as two or more axles or other wheel-engaging members, for example, with a suspension system disposed therebetween. Typically, such a suspension system will include a plurality of spring devices as well as a plurality of damping devices that together permit the sprung and unsprung masses of the vehicle to move in a somewhat controlled manner relative to one another. Generally, the plurality of spring elements function to accommodate forces and loads associated with the operation and use of the vehicle, and the plurality of damping devices are operative to dissipate undesired inputs and movements of the vehicle, particularly during dynamic operation thereof. Movement of the sprung and unsprung masses toward one another is normally referred to in the art as jounce motion while movement of the sprung and unsprung masses away from one another is commonly referred to in the art as rebound motion.

In some cases, the spring devices of vehicle suspension systems can be of a type and kind that are commonly referred to in the art as gas spring assemblies, which are understood to utilize pressurized gas as the working medium thereof. Typically, such gas spring assemblies include a flexible spring member that is operatively connected between comparatively rigid end members to form a spring chamber. Pressurized air or other pressurized gas can be transferred into and/or out of the spring chamber to alter the position of the sprung and unsprung masses relative to one another and/or to provide other performance-related characteristics. Additionally, a variety of devices and/or arrangements have been and are currently used to assist in controlling the transfer of pressurized gas into and/or out of one or more spring chambers and thereby adjust the position and/or orientation of one structural component of a vehicle relative to another structural component. As one example, a mechanical linkage valve that is in fluid communication between a compressed gas source and a gas spring assembly can be interconnected between the opposing structural components. As the structural components move toward and away from one another, the valve opens and closes to permit pressurized gas to be transferred into and out of the gas spring assembly. In this manner, such mechanical linkage valves can permit control of the height of the gas spring assembly.

Unfortunately, such arrangements have a number of problems and/or disadvantages that are commonly associated with the continued use of the same. One problem with the use of mechanical linkage valves, particularly those used in association with the suspension system of a vehicle is that the linkages are frequently subjected to physical impacts, such as may be caused by debris from a roadway, for example. This can result in the linkage being significantly damaged or broken, such that the valve no longer operates properly, if the valve operates at all.

Due to the potential for known mechanical linkage valves to be damaged, regular inspection and replacement of such mechanical linkage valves is typically recommended. Another disadvantage of known mechanical linkage valves relates to the performance and operation thereof in connection with an associated suspension system. That is, known mechanical linkage valves generally open and close under predetermined height conditions regardless of the operating condition or inputs acting on the vehicle. As such, it is possible that operating conditions of the vehicle might occur during which the performance of a height change would be undesirable. Unfortunately, conventional suspension systems that utilize mechanical linkage valves are not typically capable of selective operation.

In view of the foregoing difficulties commonly associated with the use of mechanical linkage valves, height control systems for vehicle suspensions have been developed that utilize non-contact displacement sensors and thereby avoid the use of mechanical linkage valves. Such non-contact displacement sensors are commonly housed within a gas spring assembly and can utilize sound or pressure waves traveling through a fluid medium, typically at an ultrasonic frequency, to generate output signals suitable for determining the position of one structural member relative to another structural member. As an example of such an application, an ultrasonic displacement sensor could be supported on one end member of a gas spring assembly. The ultrasonic displacement sensor can be operative to send ultrasonic waves through the spring chamber of the gas spring assembly toward an opposing end member. The waves are reflected back by a suitable feature of the opposing end member, and the distance therebetween is determined in a conventional manner.

One advantage of such an arrangement over mechanical linkages is commonly housed within the gas spring assembly and is at least partially sheltered from impacts and exposure. However, numerous disadvantages also exist with the use of displacement sensors that utilize ultrasonic sound waves that travel toward and are reflected back from a distant target. As one example, sound waves can be subject to interference from external sources, such as those within the gas spring assembly or in the environment around the gas spring assembly, which can degrade or otherwise diminish the performance of the height control system. What's more, environmental factors such as pressure, temperature and relative humidity alter speed with which sound will travel through the gas within the gas spring assembly. Also, the frequencies of these known ultrasonic displacement sensors (20,000 Hertz (Hz) up to several gigahertz (GHz)) result in distance measurements that are provided at a lower resolution and at a lower sampling rate than required for modern gas spring control systems for vehicles and other applications. These and other factors can disadvantageously affect the accuracy and/or consistency with which height control systems can operate using known ultrasonic displacement sensors.

In an effort to overcome the above-noted and other disadvantages of ultrasonic displacement sensors, other known gas spring assemblies utilizes radar displacement sensors that operate using radar waves having a frequency in the range of 76-77 GHz and a wavelength of approximately 3.8 mm. While this system may, in some cases, overcome certain disadvantages associated with the use of ultrasonic height sensors, these systems may still fail to provide height measurements with the fine resolution and update rate desired for modern gas spring control systems of vehicles and other applications. Additionally, such known radar displacement sensors may, in some cases, also fails to provide the quality and type of information desired for modern vehicle control systems, such as information concerning velocity, acceleration, and/or angle at which a target is moving and/or positioned relative to the source in a package and system that can be installed in a modern gas spring, together with suitable means for powering and communicating with such a sensor in a modern vehicle control system.

Notwithstanding the widespread usage and overall success of conventional displacement sensors as described above and others, as well as the gas spring assemblies and suspension systems including such sensors, that are known in the art, it is believed that a need exists to address the foregoing and/or other challenges while providing comparable or improved performance, ease of manufacture, reduced cost of manufacture, and/or otherwise advancing the art of gas spring devices and displacement sensors therefor.

### BRIEF SUMMARY

One example of a displacement and velocity sensor in accordance with the subject matter of the present disclosure can include a millimeter wave radar source and a radar receptor connected to an associated first vehicle component. The radar source can be adapted to generate and emit radar waves of a frequency greater than or equal to 120 gigahertz (GHz) and a wavelength of 2.5 millimeters (mm) or less toward an associated target surface provided on an associated second vehicle component that is spaced from and moveable relative to the associated first vehicle component. The radar receptor can be adapted to receive reflected radar waves reflected from the associated target surface. A processor can be operably coupled to the radar source and the radar receptor. The radar receptor can be operable to generate a signal upon receiving the reflected radar waves. The processor operable to determine both a displacement distance and a relative velocity between the radar source and the associated target surface with the processor operable to determine: a displacement distance between the radar source and the target surface based upon at least one of: (i) a time of flight required for the radar waves to travel from the radar source to the target surface and then to the radar receptor; (ii) a frequency phase shift between the radar waves transmitted by the radar source and the radar waves reflected from the target surface and received by the radar receptor; and, relative velocity between the radar source and the associated target surface based on a frequency phase shift between the radar waves transmitted by the radar source and the radar waves reflected from the target surface and received by the radar receptor.

In some cases, the processor can be operable to determine a displacement and a relative velocity between the radar source and the target using pulsed Doppler or continuous wave frequency modulation radar methods that rely on time of flight and frequency phase shifts between the pulsed or continuous radar waves transmitted by the radar source and the radar waves reflected from the target surface and received by the radar receptor.

A gas spring assembly in accordance with the subject matter of the present disclosure can have a longitudinal axis. The gas spring assembly can include a flexible spring member that can include a flexible wall extending peripherally about the longitudinal axis and axially between opposing first and second ends of the flexible spring member to at least partially define a spring chamber therebetween. A first end member can be secured along the first end of the flexible spring member such that a substantially fluid-tight seal is formed therebetween. A second end member can be disposed in axially-spaced relation to the first end member. The second end member can be secured along the second end of the flexible spring member such that a substantially fluid-tight seal is formed therebetween. A millimeter wave radar source can be operatively disposed along one of the first and second end members, and a radar receptor can be supported in a fixed position relative to the millimeter wave radar source. A target surface can be located along the other of the first and second end members in axially-spaced relation to the radar source and the radar receptor. A processor can be communicatively coupled with the radar wave source and the radar wave receptor. The radar source can be operable to direct millimeter wave radar waves toward the target surface through at least a portion of the spring chamber such that the radar waves are reflected off the target surface. The radar receptor can be operable to generate a signal upon receiving the reflected radar waves reflected off the target surface. The processor can be operable to determine a displacement distance between the radar source and the target surface based upon at least one of: (i) a time of flight required for the radar waves to travel from the radar source to the target surface and then to the radar receptor; (ii) a frequency phase shift between the radar waves transmitted by the radar source and the radar waves reflected from the target surface and received by the radar receptor.

One example of a suspension system in accordance with the subject matter of the present disclosure can include a pressurized gas system that includes a pressurized gas source and a control device. The suspension system can also include at least one gas spring assembly according to the foregoing paragraph. The at least one gas spring assembly can be disposed in fluid communication with the pressurized gas source through the control device such that pressurized gas can be selectively transferred into and out of the spring chamber.

### BRIEF DESCRIPTION OF THE DRAWINGS

FIG. 1 is a schematic representation of one example of a vehicle including a suspension system with a plurality of gas spring assemblies and a plurality of displacement and velocity sensors in accordance with the subject matter of the present disclosure.

FIG. 2 is a side elevation view of one example of a gas spring assembly including one example of a displacement and velocity sensor in accordance with the subject matter of the present disclosure.

FIG. 3 is a cross-sectional side view of the gas spring assembly and displacement and velocity sensor in FIG. 2 taken from along line 3-3 in FIG. 2.

FIG. 4 is a cross-sectional side view of one example of a gas spring and damper assembly including another example of a displacement and velocity sensor in accordance with the subject matter of the present disclosure.

FIG. 5 is an enlarged view of the portion of the gas spring and damper assembly and the displacement and velocity sensor identified as Detail 5 in FIG. 4.

FIG. 6 is a schematic representation of one example of a displacement and velocity sensor in accordance with the subject matter of the present disclosure.

### DETAILED DESCRIPTION

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purpose of clarity and ease of understanding.

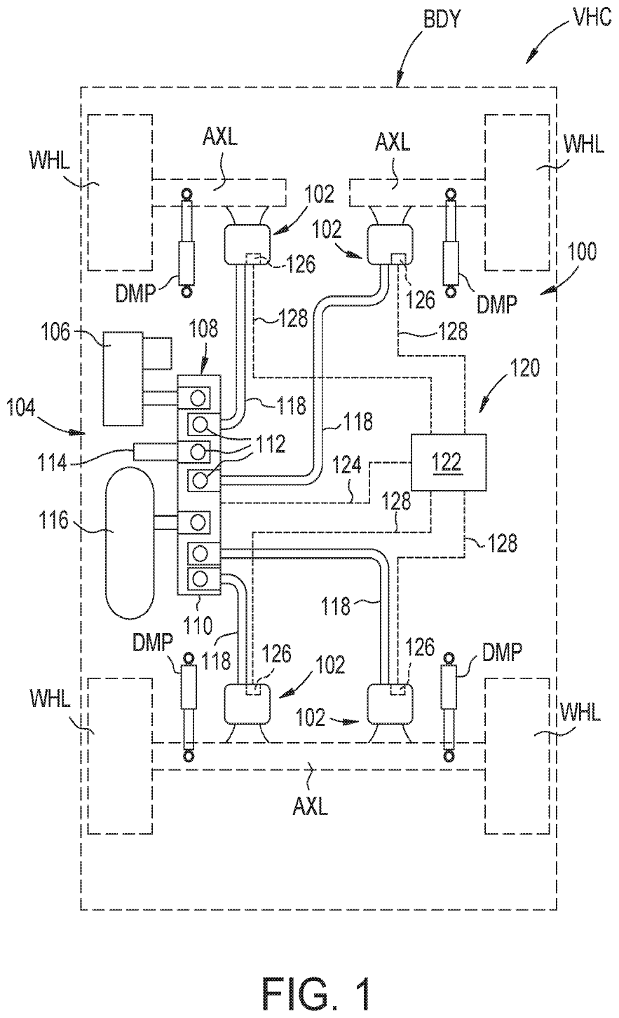

FIG. 1 illustrates one example of a suspension system 100 disposed between a sprung mass, such as an associated vehicle body BDY, for example, and an unsprung mass, such as an associated tire assembly WHL or an associated axle AXL, for example, of an associated vehicle VHC. It will be appreciated that any one or more of the components of the suspension system can be operatively connected between the sprung and unsprung masses of the associated vehicle in any suitable manner.

The suspension system can also include a plurality of gas spring assemblies 102 supported between the sprung and unsprung masses of the associated vehicle. In the arrangement shown in FIG. 1, suspension system 100 includes four gas spring assemblies 102, one of which is disposed toward each corner of the associated vehicle adjacent a corresponding wheel WHL. However, it will be appreciated that any other suitable number of gas spring assemblies could alternately be used in any other configuration and/or arrangement. As shown in FIG. 1, gas spring assemblies 102 are supported between axles AXL and body BDY of associated vehicle VHC. Additionally, it will be recognized that the gas spring assemblies shown and described in FIG. 1 (e.g., gas spring assemblies 102) are illustrated as being of a rolling lobe-type construction. It is to be understood, however, that gas spring assemblies of other types, kinds and/or constructions could alternately be used. Depending on desired performance characteristics and/or other factors, the suspension system will typically include damping members, such as dampers DMP, for example, of a typical construction that are provided separately from gas spring assemblies 102 and secured between the sprung and unsprung masses in a conventional manner.

Suspension system 100 also includes a pressurized gas system 104 operatively associated with the gas spring assemblies for selectively supplying pressurized gas (e.g., air) thereto and selectively transferring pressurized gas therefrom. In the exemplary embodiment shown in FIG. 1, pressurized gas system 104 includes a pressurized gas source, such as a compressor 106, for example, for generating pressurized air or other gases. A control device, such as a valve assembly 108, for example, is shown as being in communication with compressor 106 and can be of any suitable configuration or arrangement. In the exemplary embodiment shown, valve assembly 108 includes a valve block 110 with a plurality of valves 112 supported thereon. Valve assembly 108 can also, optionally, include a suitable exhaust, such as a muffler 114, for example, for venting pressurized gas from the system. Optionally, pressurized gas system 104 can also include a reservoir 116 in fluid communication with the compressor and/or valve assembly 108 and suitable for storing pressurized gas.

Valve assembly 108 is in communication with gas spring assemblies 102 through suitable gas transfer lines 118. As such, pressurized gas can be selectively transferred into and/or out of the gas spring assemblies through valve assembly 108 by selectively operating valves 112, such as to alter or maintain vehicle height at one or more corners of the vehicle, for example.

Suspension system 100 can also include a control system 120 that is capable of communication with any one or more systems and/or components (not shown) of vehicle VHC and/or suspension system 100, such as for selective operation and/or control thereof. Control system 120 can include a controller or electronic control unit (ECU) 122 communicatively coupled with compressor 106 and/or valve assembly 108, such as through a conductor or lead 124, for example, for selective operation and control thereof, which can include supplying and exhausting pressurized gas to and/or from gas spring assemblies 102. Controller 122 can be of any suitable type, kind and/or configuration.

In accordance with the subject matter of the present disclosure, control system 120 can also include one or more sensing devices 126 that may be operatively associated with the gas spring assemblies 102 and capable of outputting or otherwise generating data, signals and/or other communications having a relation to a height of the gas spring assemblies, a distance between other components of the vehicle, and/or velocity or acceleration at which components of the gas spring assemblies 102 or components of the vehicle are moving with respect to each other. Sensing devices 126 can be in communication with ECU 122, which can receive the distance (height), velocity, and/or acceleration signals, data and/or information therefrom. Sensing devices 126 can be in communication with ECU 122 in any suitable manner, such as through conductors or leads 128, for example or by way of a wireless radio frequency or other wireless interface.

In a preferred arrangement, in accordance with the subject matter of the present disclosure, sensing devices 126 can be located inside the spring chamber of gas spring assemblies 102 and can be of a type, kind and/or construction that utilizes a radio wave (radar) transmitter operable to direct millimeter wavelength radar waves of a frequency greater than 120 gigahertz (GHz) and a wavelength of less than or equal to 2.5 millimeters (mm) toward a target surface inside the spring chamber. In one embodiment, sensor devices 126 transmit radar waves of a frequency inclusively in the range of 120 to 240 gigahertz (GHz), corresponding respectively to a wavelength inclusively in the range of 2.5 to 1.25 millimeters (mm). The target surface can be another component of gas spring assembly 102 located inside the spring chamber. Sensing devices 126 include a radar receptor that receives radar waves reflected off of the target surface can be operable to generate a signal based upon the received reflected radar waves.

Sensing devices 126 include a processor that utilizes the signal generated by the radar receptor to derive a distance (displacement) between the radar source and the target surface, and optionally also the relative velocity, acceleration, angle, and/or changes in the angle between the radar source and the target surface, based at least one of: (i) the time of flight for a radar wave to travel from the radar source to the target and then to the radar receptor; (ii) a frequency shift (or “phase shift”) between the radar waves transmitted by the radar source and the radar waves reflected from the target surface and received by the radar receptor using a pulsed Doppler method or a continuous wave frequency modulation (CWFM) method; (iii) the angle of arrival or change in angle of arrival of radar waves reflected from the target surface and received by the radar receptor. The angle of arrival is defined as the angle between the radar receptor (which can comprise an array of multiple receiver antennae) and the received radar waves reflected from the target. The distance derived by the processor has a relationship to a height of the gas spring assembly, itself, and/or has a relationship to a distance between other components of the vehicle. The angle or arrival or changes in same can provide information concerning the road surface and/or vehicle load (or load shift). All of the information provided can be useful as input to vibration control and/or active damping systems of vehicle VHC.

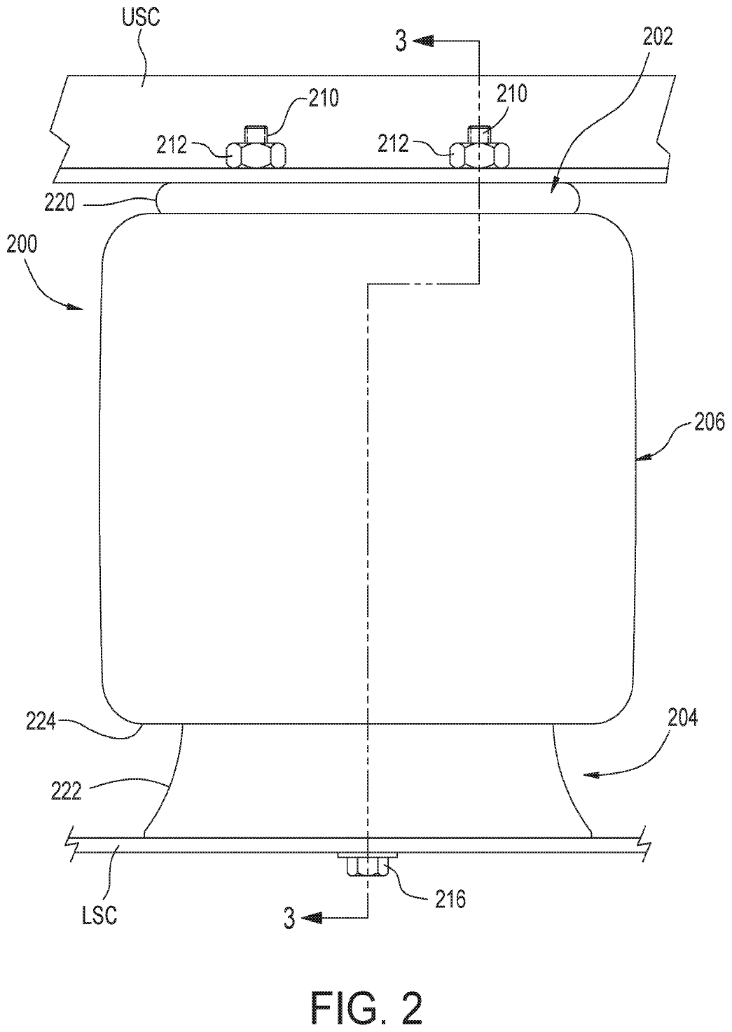

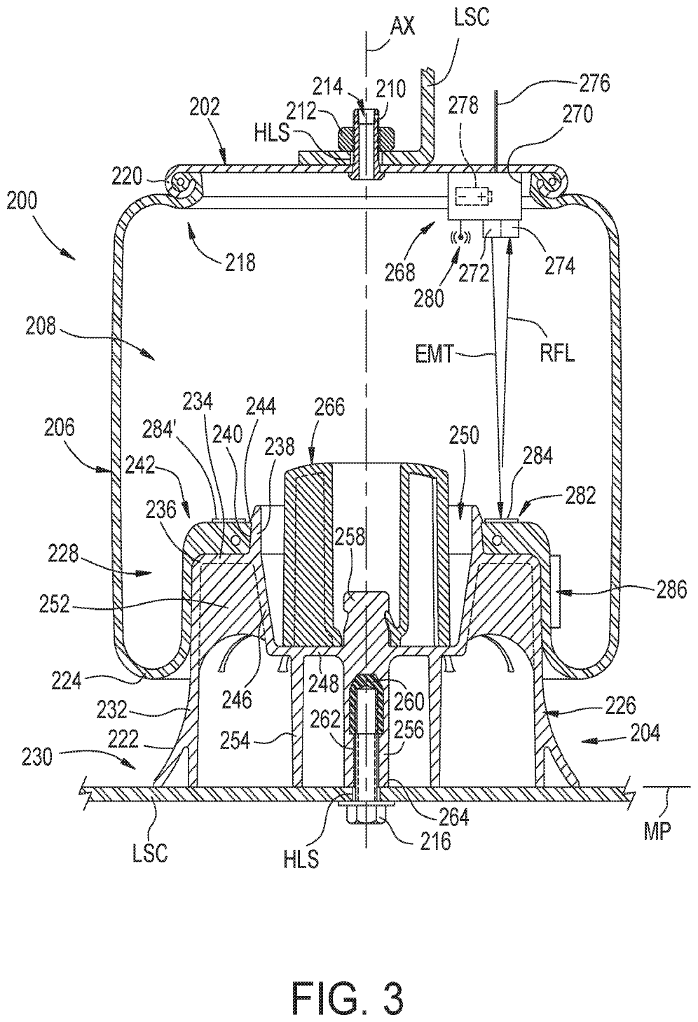

A gas spring assembly 200 in accordance with the subject matter of the present disclosure is shown in FIGS. 2 and 3 and is suitable for use as a gas spring assembly 102 described above. Gas spring assembly 200 has a longitudinally-extending axis AX (FIG. 3) and can include one or more end members, such as an end member 202 and an end member 204 that is spaced longitudinally from end member 202. An elastomeric flexible spring member 206 can extend peripherally around axis AX and can be secured between the end members in a substantially fluid-tight manner such that a spring chamber 208 (FIG. 3) is at least partially defined therebetween.

Gas spring assembly 200 can be disposed between associated sprung and unsprung masses of an associated vehicle in any suitable manner. For example, one end member can be operatively connected to the associated sprung mass with the other end member disposed toward and operatively connected to the associated unsprung mass. In the arrangement shown in FIGS. 2 and 3, for example, end member 202 is secured along a first or upper structural component USC, such as associated vehicle body BDY in FIG. 1, for example, and can be secured thereon in any suitable manner. For example, one or more securement devices, such as mounting studs 210, for example, can be included along end member 202. In some cases, the one or more securement devices (e.g., mounting studs 210) can project outwardly from end member 202 and can be secured thereon in a suitable manner, such as, for example, by way of a flowed-material joint (not shown) or a press-fit connection (not identified). Additionally, such one or more securement devices can extend through mounting holes HLS (FIG. 3) in upper structural component USC and receive one or more threaded nuts 212 or other securement devices, for example. As an alternative to one or more of mounting studs 210, one or more threaded passages (e.g., blind passages and/or through passages) could be used in conjunction with a corresponding number of one or more threaded fasteners.

Additionally, a fluid communication port, such as a transfer passage 214 (FIG. 3), for example, can optionally be provided to permit fluid communication with spring chamber 208, such as may be used for transferring pressurized gas into and/or out of the spring chamber, for example. In the exemplary embodiment shown, transfer passage 214 extends through at least one of mounting studs 210 and is in fluid communication with spring chamber 208. It will be appreciated, however, that any other suitable fluid communication arrangement could alternately be used.

End member 204 can be secured along a second or lower structural component LSC, such as an axle AXL in FIG. 1, for example, in any suitable manner. As one example, lower structural component LSC could include one or more mounting holes HLS extending therethrough. In such case, a threaded fastener 216 could extend through one of mounting holes HLS and threadably engage end member 204 to secure the end member on or along the lower structural component.

It will be appreciated that the one or more end members 202 and 204 can be of any suitable type, kind, construction and/or configuration, and can be operatively connected or otherwise secured to flexible spring member 206 in any suitable manner. In the exemplary arrangement shown in FIGS. 2 and 3, for example, end member 202 is of a type commonly referred to as a bead plate and is secured to a first end 218 of flexible spring member 206 using a crimped-edge connection 220. End member 204 is shown in the exemplary arrangement in FIGS. 2 and 3 as being of a type commonly referred to as a piston (or a roll-off piston) that has an outer surface 222 that abuttingly engages flexible spring member 206 such that a rolling lobe 224 is formed therealong. As gas spring assembly 200 is displaced between extended and collapsed conditions and end plates 202 and 204 move toward and away from each other, rolling lobe 224 is displaced along outer surface 222 in a conventional manner.

As identified in FIG. 3, end member 204 includes an end member body 226 and extends from along a first or upper end 228 toward a second or lower end 230 that is spaced longitudinally from end 228. Body 226 includes a longitudinally-extending outer side wall 232 that extends peripherally about axis AX and at least partially defines outer surface 222. An end wall 234 is disposed transverse to axis AX and extends radially inward from along a shoulder portion 236, which is disposed along the outer side wall toward end 228. Body 226 also includes a first inner side wall 238 that extends longitudinally outward beyond end wall 234 and peripherally about axis AX. First inner side wall 238 has an outer surface 240 that is dimensioned to receive a second end 242 of flexible spring member 206 such that a substantially fluid-tight seal can be formed therebetween. A retaining ridge 244 can project radially outward from along first inner side wall 238 and can extend peripherally along at least a portion thereof.

Body 226 also includes a second inner side wall 246 that extends longitudinally inward into the body from along end wall 234. Second inner side wall 246 terminates at an end or bottom wall 248 that is approximately planar and disposed transverse to axis AX such that second inner side wall 246 and bottom wall 248 at least partially define a cavity 250 within body 226. In some cases, bridge walls 252 can, optionally, extend between and operatively interconnect outer side wall 232 and second inner side wall 246.

An inner support wall 254 is disposed radially inward from outer side wall 232 and extends peripherally about axis AX. In some cases, inner support wall 254 can form a hollow column-like structure that projects from along bottom wall 248 in a longitudinal direction toward end 230. In some cases, the distal end of outer side wall 232 and/or the distal end of inner support wall 254 can at least partially define a mounting plane MP formed along end 230 of the end member body. In this manner, body 226 can be supported at least in part by outer side wall 232 and/or inner support wall 254, such as on or along an associated structural member (e.g., lower structural component LSC in FIGS. 2 and 3). In some cases, axially applied loads or forces transmitted to bottom wall 248, such as from impacts imparted on a jounce bumper, for example, can be reacted, communicated or otherwise at least partially transferred to the associated mounting structure by the inner support wall. Body 226 can also include a central or support post wall 256 that is disposed radially inward from inner support wall 254 and forms a post-like structure that projects from along bottom wall 248 in a direction toward end 230. In some cases, central wall 256 can terminate in approximate alignment with mounting plane MP, such as is illustrated in FIG. 3, for example.

Additionally, end member body 226 of end member 204 can include a bumper mount 258 that is disposed along bottom wall 248 and projects outwardly therefrom in an axial direction toward end 228 of the end member body. Additionally, as indicated above, end member 204 can include any number of one or more features and/or components. For example, end member 204 can include an insert 260 that is embedded (e.g., molded) into or otherwise captured and retained within end member body 226. Insert 260 can function to assist in securing the end member on or along an associated structural component, such as providing a mounting and/or securement point for the end member 204 on the lower structural component LSC in FIGS. 2 and 3. As one example, insert 260 can include a hole or opening 262 that can extend into the insert body from along an end surface 264. In a preferred arrangement, the insert body can include a securement feature. In the arrangement shown, the securement feature can take the form of one or more helical threads that are cooperative with corresponding securement features (e.g., one or more helical threads formed on or along threaded fastener 216.

Gas spring assembly 200 can also, optionally, include a jounce bumper 266 that can be supported within spring chamber 208, such as to inhibit direct contact between end members 202 and 204, for example. It will be appreciated that the jounce bumper, if included, can be supported on or along an end member in any suitable manner. For example, jounce bumper 266 is shown as being received on and retained in position on or along end member 204 by bumper mount 258.

Gas spring assembly 200 is also shown in FIG. 3 as including a sensor in accordance with the subject matter of the present disclosure. It will be appreciated that a sensor in accordance with the subject matter of the present disclosure can be operatively supported within the spring chamber 208 of the gas spring assembly 200 in any suitable manner, and can include one or more components supported on or along either or both of end members 202 and/or 204. For example, in the arrangement shown in FIG. 3, a sensor 268, corresponding to the sensing device 126 described above, is shown as being disposed within spring chamber 208 and supported along end member 202. Sensor 268 includes a sensor housing 270 that is secured in a suitable manner to end member 202. In accordance with the subject matter of the present disclosure, sensor 268 also includes a millimeter wave radar source 272 and a millimeter wave radar receptor 274. In a preferred arrangement, such as is shown in FIG. 3, radar source 272 and radar receptor 274 can be operatively disposed along a common component (e.g., one of end members 202 and 204) and in proximal relation to one another as part of the same component or as part of separate adjacent components. However, it will be appreciated that other configurations and/or arrangements could alternately be used in which radar source 272 and radar receptor 274 are maintained in a fixed position relative to one another without departing from the subject matter of the present disclosure.

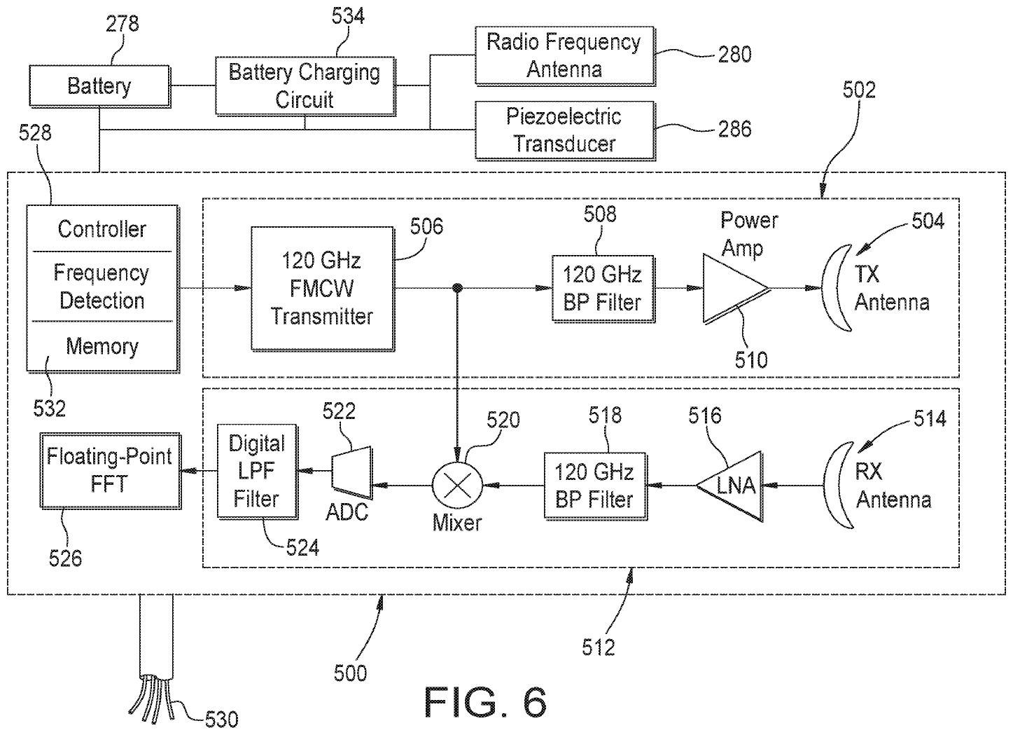

Additionally, it will be appreciated that sensor 268 can be connected to other systems and/or components of a vehicle suspension system in any suitable manner. For example, sensor 268 could include one or more leads or conductors 276 that can be used to provide electrical power to the sensor and/or for bidirectional communication purposes (e.g., signals, data, information and/or communication transfer to and/or from the sensor), such as is indicated by leads 128 of control system 120 in FIG. 1, for example. Additionally, or in the alternative, sensor 268 can include a self-contained, rechargeable power source 278 (e.g., batteries) and/or an antenna 280 suitable for wireless reception and/or transmission of signals, data and/or information for communication and/or other purposes. In some cases, antenna 280 (or second antenna) can be included and connected to a radio frequency charging circuit 534 (FIG. 6) used to harvest electrical energy from the received radio frequency (“RF”) waves and provide wireless electrical power to the sensor from RF energy transmitted by vehicle VHC for direct use and/or for recharging power source 278. In one embodiment, flexible spring member 206 or other part of gas spring assembly 200 can include a piezo-electric or similar electromechanical transducer or other vibration energy harvesting device 286 that converts kinetic energy in the form of vibration or movement into electrical energy, such as movement of first and second end members 202 and 204 or other mechanical movement of the gas spring assembly 200 during its use into electrical energy used to power sensor 268 directly and/or indirectly via electrical power to recharge power source 278. Vibration energy harvesting device 286 can also be an electromagnetic energy generator that generates electrical power via electromagnetic induction based upon relative movement between a coil and a magnetic field.

During use, in accordance with the subject matter of the present disclosure, sensor 268 is shown in FIG. 3 as being operable emit to millimeter wave radar waves having a frequency inclusively in the range of 120 to 240 gigahertz (GHz), corresponding to a wavelength inclusively in the range of 2.5 to 1.25 millimeters (mm), from radar source 272 in a direction toward a target feature or component 282 for which a displacement (height or distance) is to be determined, as is represented by arrow EMT. Target feature or component 282 can be provided by any part of the gas spring assembly internal to the spring chamber 208 that is generally spaced-apart from, opposed to, and moveable with respect to the radar source 272, such as any part of end member 204, second end 242 of flexible spring member 206, jounce bumper 266, and/or the like. Emitted radar waves EMT are incident upon target feature or component 282 and are then reflected off of the target feature or component in a direction back toward radar receptor 274, as is represented by arrow RFL. In accordance with the subject matter of the present disclosure, sensor 268 will operate properly while reflecting radar waves off of a surface of target feature 282 or component itself, without any specialized reflector or coating. In some cases, however, it may be desirable to provide a separate, specialized reflective target 284 having a reflective radar target surface with predetermined reflective properties, such as may be useful to provide a particular level of performance or robustness of operation.

For example, though optional, gas spring assembly 200 and/or sensor 268 can include a specialized separate reflective target 284 having a target surface off of which the millimeter wave radar signals can be reflected from source 272 toward receptor 274, such as is shown in FIG. 3, for example. It will be appreciated that reflective target 284 and target surface thereof can be of any suitable size, shape and/or configuration. For example, reflective target 284 is shown in FIG. 3 as being a spot target disposed in a desired position along end member 204 relative to sensor 268. In the alternative, an annular reflective target 284′ could be used that extends peripherally about axis AX such that an annular target surface is provided that will align with sensor 268 regardless of the rotational orientation of the sensor and the reflective target relative to one another about axis AX. Again, depending upon the anticipated conditions of use in a particular application and the desired performance characteristics and/or robustness of operation, the target surface (whether a surface of the target feature or component 282 or a dedicated reflective surface, such as reflective target 284) can be positioned and configured to provide optimized reflectance of the transmitted radar waves under all operative conditions of the gas spring assembly.

Sensor 268, or a system or component operatively associated with the sensor, can be operable to determine time of flight of the radar waves traveling at the speed of light (i.e., 299,792,458 meters per second (m/s) in air) from radar source 272 to the target surface (e.g., surface of target 282, 284 and/or 284′) and then to radar receptor 274. It will be appreciated that the roundtrip distance traveled by the radar waves will have a relation to the time of flight. Thus, by determining the time of flight of the radar waves, sensor 268, or a system or component operatively associated with the sensor (such as controller 122 or another processor), can then determine a height or distance associated with the gas spring assembly or other components of a suspension system.

Additionally, or alternatively, sensor 268, or a system or component operatively associated with the sensor, can be operable to determine a frequency shift or phase shift between the radar waves EMT transmitted by radar source 272 and radar waves RFL reflected from the target surface (e.g., surface of target 282, 284 and/or 284′) and received by radar receptor 274 using pulsed Doppler radar pulses or continuous wave frequency modulation (CWFM) of continuously transmitted radar waves. In either case, it will be appreciated that, based upon the Doppler effect, the frequency shift exhibited by reflected radar waves RFL relative to the transmitted radar waves EMT will have a relation to relative movement between source 272 and the target surface (e.g., surface of target 282, 284 and/or 284′). Thus, by determining the phase shift of the radar waves, sensor 268, or a system or component operatively associated with the sensor (such as controller 122 or another processor), can then determine displacement (distance/height) between source 272 and the target surface (e.g., surface of target 282, 284 and/or 284′) and can also determine the velocity and/or acceleration of radar source 272 (or a component connected thereto) relative to the target surface (e.g., surface of target 282, 284 and/or 284′) or a component connected thereto. Sensor 268, or a system or component operatively associated with the sensor, can be operative to update such measurements rapidly to assess changes over time.

Furthermore, sensor 268, or a system or component operatively associated with the sensor, can operatively monitor and assess the angle of arrival or changes in the angle of arrival of reflected radar waves RFL as received by receptor 274. The angle of arrival or changes in the angle of arrival allow sensor 268, or a system or component operatively associated with the sensor, to determine the angle or changes in the angle between the target surface (e.g., surface of target 282, 284 and/or 284′) and radar source 272 and/or receptor 274. Accordingly, sensor 268, or a system or component operatively associated therewith, is operable to determine a distance between, the angle between, changes in the angle between, velocity difference between, and/or acceleration between radar wave source 272 and the target surface (e.g., surface of target 282, 284 and/or 284′).

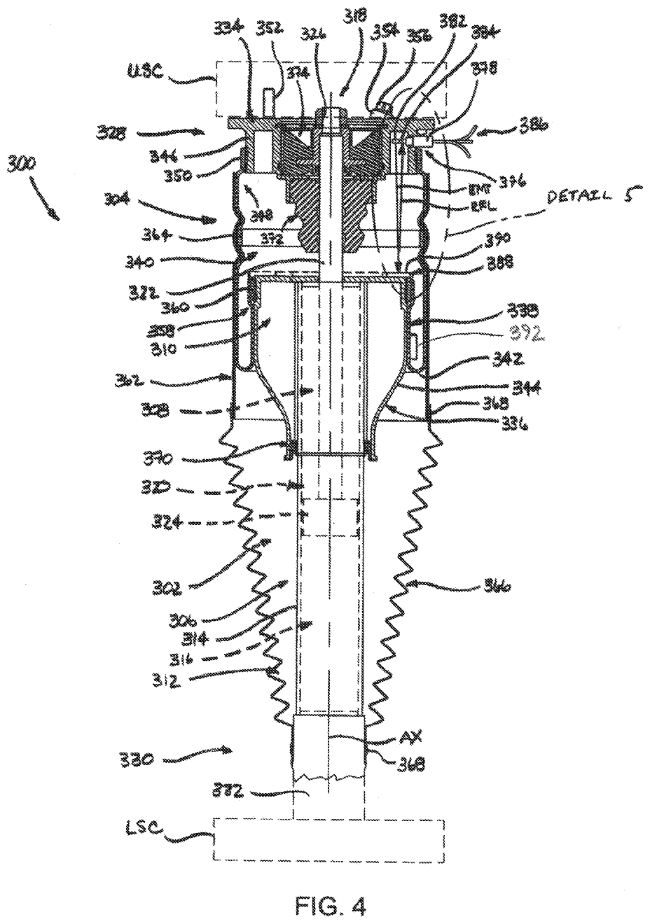

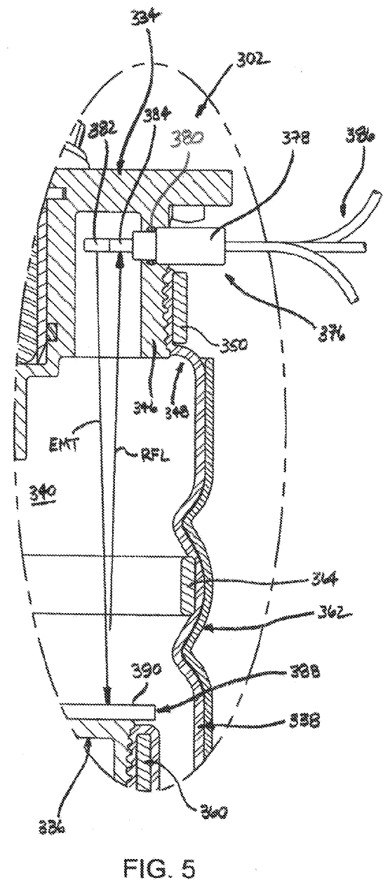

Another example of a gas spring assembly in accordance with the subject matter of the present disclosure can take the form of a gas spring and damper assembly 300, as is shown in FIGS. 4 and 5. Gas spring and damper assembly 300 can include a damper assembly 302 and a gas spring assembly 304 that is operatively connected with the damper assembly. It will be appreciated that, in some cases, gas spring and damper assembly 300 can, for example, be installed on an associated vehicle to at least partially form an associated suspension thereof. In such cases, gas spring and damper assembly 300 can undergo changes in length (i.e., can be displaced between extended and collapsed conditions) and thereby allow the components of the vehicle and the suspension system thereof to dynamically move to accommodate forces and/or inputs acting on the vehicle, such as has been described above and is well understood by those of skill in the art.

Gas spring and damper assembly 300 is shown in FIGS. 4 and 5 as having a longitudinally-extending axis AX with damper assembly 302 and gas spring assembly 304 operatively secured to one another around and along axis AX. Damper assembly 302 is shown in FIGS. 4 and 5 as extending along axis AX and including a damper housing 306 and a damper rod assembly 308 that is at least partially received in the damper housing. Damper housing 306 can extend axially between opposing housing ends 310 and 312, and can include a housing wall 314 that at least partially defines a damping chamber 316. Damper rod assembly 308 can extend lengthwise between opposing ends 318 and 320 and can include an elongated damper rod 322 and a damper piston 324 disposed along end 320 of damper rod assembly 308. Damper piston 324 is received within damping chamber 316 of damper housing 306 for reciprocal movement along the housing wall in a conventional manner. A quantity of damping fluid (not shown) can be disposed within damping chamber and damper piston 324 can be displaced through the damping fluid to dissipate kinetic energy acting on gas spring and damper assembly 300, again, in a conventional manner. Though damper assembly 302 is shown and described herein as having a conventional construction in which a hydraulic fluid is contained within at least a portion of damping chamber 316, it will be recognized and appreciated that dampers of other types, kinds and/or constructions, such as pressurized gas or “air” dampers, for example, could be used without departing from the subject matter of the present disclosure.

Elongated rod 322 is shown in FIGS. 4 and 5 projecting out of damper housing 306 such that the elongated rod is outwardly exposed from the damper housing and is externally accessible with respect to the damper housing. A connection feature 326, such as a plurality of threads, for example, can be provided on or along the elongated rod for use in operatively connecting gas spring and damper assembly 300 to an associated vehicle structure, a component of gas spring assembly 304 or another component of gas spring and damper assembly 300.

It will be appreciated that gas spring and damper assembly 300 can be operatively connected between associated sprung and unsprung masses of an associated vehicle VHC (or other construction) in any suitable manner. For example, one end of the assembly can be operatively connected to the associated sprung mass with the other end of the assembly disposed toward and operatively connected to the associated unsprung mass. As shown in FIGS. 4 and 5, for example, a first or upper end 328 of assembly 300 can be secured on or along a first or upper structural component USC, such as an associated vehicle body, for example, and can be secured thereon in any suitable manner. A second or lower end 330 of assembly 300 can be secured on or along a second or lower structural component LSC, such as an associated axle or suspension structure of a vehicle, for example, and can be secured thereon in any suitable manner. In some cases, damper assembly 302 can include a connection feature 332, such as a pivot or bearing mount (not shown), for example, that is operatively disposed along damper housing 306 and is adapted for securement to lower structural component LSC in a suitable manner.

Gas spring assembly 304 includes an end member 334, such as a top cap, bead plate or reservoir enclosure, for example. Gas spring assembly 304 also includes an end member 336, such as a roll-off piston or piston assembly, for example, that is disposed in axially-spaced relation to end member 334. A flexible spring member 338 can be operatively connected between end members 334 and 336 in a substantially fluid-tight manner such that a spring chamber 340 is at least partially defined therebetween. In some cases, flexible spring member 338 can form a rolling lobe 342 that is displaced along an outer surface 344 of end member 336 as gas spring and damper assembly 300 moves between extended (i.e., rebound) and compressed (i.e., jounce) conditions. As shown in FIGS. 4 and 5, end member 336 can include a wall portion 346 along which one end 348 of flexible spring member 338 is operatively connected, such as, for example, through the use of a retaining ring 350 that can be crimped radially inward or otherwise deformed to form a substantially fluid-tight connection therebetween.

As discussed above, gas spring and damper assembly 300 can be operatively connected between associated sprung and unsprung masses of an associated vehicle (or other structure) in any suitable manner. As shown in FIGS. 4 and 5, for example, end 328 of assembly 300 can be secured on or along upper structural component USC in any suitable manner. As one example, one or more securement devices, such as mounting studs 352, for example, can be included along end member 334. In some cases, the one or more securement devices (e.g., mounting studs 352) can project outwardly from end member 334 and can be secured thereon in a suitable manner, such as, for example, by way of a flowed-material joint (not shown) or a press-fit connection (not identified). Additionally, such one or more securement devices can extend through mounting holes (not shown) in upper structural component USC and can receive one or more threaded nuts (not shown) or other securement devices, for example. Additionally, or as an alternative to one or more of mounting studs 352, one or more threaded passages (e.g., blind passages and/or through passages) could be used in conjunction with a corresponding number of one or more threaded fasteners.

A fluid communication port can optionally be provided to permit fluid communication with spring chamber 340, such as may be used for transferring pressurized gas into and/or out of the spring chamber, for example. It will be appreciated that such a fluid communication port can be provided in any suitable manner. As one example, a fluid communication port could extend through one or more of mounting studs 352. As another example, end member 334 can include a transfer passage 354 extending therethrough that is in fluid communication with spring chamber 340. It will be appreciated, however, that any other suitable fluid communication arrangement could alternately be used. In some cases, passage 354 can be adapted to receive a suitable connector fitting 356, such as may be suitable for operatively connecting gas transfer lines 118 in FIG. 1, for example, or other elements of a pressurized gas system to the gas spring and damper assembly.

An opposing end 358 of flexible sleeve 338 can be secured on or along end member 334 in any suitable manner. As one example, a portion of the flexible sleeve can be secured in abutting engagement along a wall portion of end member 334 by way of a retaining ring 360 that can be crimped radially inward or otherwise deformed to form a substantially fluid-tight connection therebetween. Additionally, gas spring and damper assembly 300 can, optionally, include an external sleeve or support, such as a restraining cylinder 362, for example, that can be secured on or along the flexible sleeve in any suitable manner. As one example, a portion of the flexible sleeve can be secured in abutting engagement along a wall portion of restraining cylinder 362 by way of a retaining ring 364 that can be crimped radially outward or otherwise deformed to form engagement between the restraining cylinder and the flexible sleeve. It will be appreciated, however, that other arrangements could alternately be used.

Gas spring and damper assembly 300 can also, optionally, include one or more additional components and/or features. For example, an accordion-type bellows 366 can extend along at least a portion of the gas spring and damper assembly and can be secured to one or more components thereof in any suitable manner, such as by way of retaining rings 368, for example. As another example, a seal assembly 370 can be disposed in fluid communication between damper housing 306 and end member 336, such that a substantially fluid-tight seal can be formed therebetween. As a further example, a jounce bumper 372 can be disposed within spring chamber 340 and can be supported on or along one of end members 334 and 336 in a suitable manner. In the arrangement shown in FIGS. 4 and 5, jounce bumper 372 is received along elongated rod 322 and supported on end member 334. It will be appreciated, however, that other configurations and/or arrangements could alternately be used. Gas spring and damper assembly 300 can also include a damper rod bushing 374 that is operatively connected between elongated rod 322 of damper assembly 302 and end member 334 of gas spring assembly 304. In this manner, forces acting on one of damper rod 322 and end member 334 that are experienced during use of the gas spring and damper assembly are transmitted or otherwise communicated through damper rod bushing 374 to the other of damper rod 322 and end member 334.

Gas spring assembly 304 of gas spring and damper assembly 300 is also shown in FIGS. 4 and 5 as including a sensing device 376 in accordance with the subject matter of the present disclosure for sensing the distance, relative velocity and/or acceleration, and/or angle between components of the damper assembly 300 or between components of the gas spring assembly portion thereof. It will be appreciated that a sensor 376 in accordance with the subject matter of the present disclosure can be operatively supported within the spring chamber of the gas spring assembly in any suitable manner, and can include one or more components supported on or along either or both of end members 334 and/or 336. For example, in the arrangement shown in FIGS. 4 and 5, sensor 376 is disposed within spring chamber 340 and supported along end member 334. Sensor 376 can include a sensor body or housing 378 that is secured in a suitable manner on or along end member 334. In a preferred arrangement, end member 334 (or, alternately, end member 336) can include a passage (not numbered) extending therethrough that is oriented transverse to axis AX. The passage can be dimensioned to cooperatively engage sensor body 378 such that sensor 376 can be operatively secured on or along the end member. In some cases, one or more sealing elements 380 can be disposed between sensor body 378 and the end member wall portion such that a substantially fluid-tight seal can be formed and maintained therebetween.

In accordance with the subject matter of the present disclosure, sensor 376 also includes a millimeter wave radar source 382 and a millimeter wave radar receptor 384. In a preferred arrangement, such as is shown in FIGS. 4 and 5, for example, the radar source and radar receptor can be operatively disposed along a common component (e.g., one of end members 334 and 336) and in proximal relation to one another. However, it will be appreciated that other configurations and/or arrangements could alternately be used in which radar source 382 and radar receptor 384 are maintained in a fixed position relative to one another without departing from the subject matter of the present disclosure.

Additionally, it will be appreciated that sensor 376 can be communicatively coupled or otherwise connected to other systems and/or components of a vehicle suspension system in any suitable manner. For example, sensor 376 could include one or more leads or conductors 386 that can be used to provide electrical power to the sensor and/or for communication purposes (e.g., signals, data, information and/or communication transfer to and/or from the sensor), such as is indicated by leads 128 of control system 120 in FIG. 1, for example. Additionally, or in the alternative, the sensor can include a self-contained power source (e.g., batteries) and/or an antenna suitable for wireless reception and/or transmission of signals, data, information, and/or electrical power for communication and/or other purposes, such as has been described above in connection with power source 278 and/or antenna 280, for example. In one embodiment, flexible spring member 338 or other parts of gas spring assembly 304 can include a piezo-electric or similar electromechanical transducer 392 that converts mechanical energy from the movement of the end members 334 and 336 toward and away from each other or other cyclic mechanical movement of gas spring assembly 304 during its use into electrical energy used to power sensor 376 directly and/or indirectly via electrical power to recharge a power source thereof.

During use, in accordance with the subject matter of the present disclosure, sensor 376 is shown in FIGS. 4 and 5 as being operable to generate and emit millimeter wavelength radar waves having a frequency inclusively in the range of 120 to 240 gigahertz (GHz), corresponding to a wavelength inclusively in the range of 2.5 to 1.25 millimeters (mm) from radar source 382 in a direction toward a target feature or component 388 for which a height or distance is to be determined, as is represented by arrow EMT. Target feature or component 388 can be provided by any part of assembly 300 that is generally spaced-apart from, opposed to, and moveable with respect to the radar source 382, such as any part of end member 336 or damper housing 306, for example. Emitted radar waves EMT are reflected off of target feature or component 388 in a direction back toward radar receptor 384, as is represented by arrow RFL.

In accordance with the subject matter of the present disclosure, sensor 376 will operate properly while reflecting radar waves off of a surface of target feature or component 388 itself, without using any specialized reflector or coating on the target. In some cases, however, it may be desirable to separately provide a target 390 having a separate, specialized radar reflective target surface with predetermined reflective properties, such as may be useful to provide a particular level of performance or robustness of operation. For example, though optional, gas spring assembly 304 and/or sensor 376 can include a reflective target 390 having a target surface off of which radar waves can be reflected from radar source 382 toward radar receptor 384, such as is shown in FIGS. 4 and 5, for example. It will be appreciated that reflective target 390 and target surface thereof can be of any suitable size, shape and/or configuration. For example, reflective target 390 is shown in FIGS. 4 and 5 as being a spot target disposed in a desired position along end member 336 relative to sensor 376. In the alternative, reflective target 390 can be provided such that it extends peripherally about axis AX to provide an annular target surface that will align with sensor 376 regardless of the rotational orientation of the sensor and the reflective target relative to one another about axis AX.

Again, depending upon the anticipated conditions of use in a particular application and the desired performance characteristics and/or robustness of operation, the target surface (whether a surface of the target feature or component of the 388 or a dedicated reflective target 390) can have particular radar reflective properties to enhance and control the reflected radar waves.

Sensor 376, or a system or component operatively associated with the displacement and velocity sensor, can be operable to determine time of flight of the radar waves traveling at the speed of light (i.e., 299,792,458 meters per second (m/s) in air) from the radar source 382, to target 388 and/or 390 and then to radar receptor 384. It will be appreciated that the roundtrip distance traveled by the radar waves will have a relation to the time of flight. Thus, by determining the time of flight of the radar waves, sensor 376, or a system or component operatively associated with the sensor (such as controller 122 or another processor), can then determine a height or distance associated with assembly 300 or other components of the suspension system and/or vehicle.

Additionally, or alternatively, sensor 376, or a system or component operatively associated with the sensor (such as the controller 122), can be operable to determine a frequency shift or phase shift between radar waves EMT transmitted by radar source 382 and radar waves RFL reflected from target surface 388 and/or 390 and received by radar receptor 384 using pulsed Doppler radar pulses or continuous wave frequency modulation (CWFM) of continuously transmitted radar waves. In either case, due to the Doppler effect, it will be appreciated that the frequency shift exhibited by reflected radar waves RFL relative to transmitted radar waves EMT will have a relation to relative movement between the source 382 and target 388 and/or 390. Thus, by determining the phase shift of the radar waves, sensor 376, or a system or component operatively associated with the sensor (such as controller 122 or another processor), can then determine displacement (distance/height) between source 382 and target 388 and/or 390 and can also determine the velocity and acceleration of radar source 382 (or a component connected thereto) relative to target 388 and/or 390 (or a component connected thereto).

Furthermore, sensor 376, or a system or component operatively associated with the sensor (such as controller 122), can operatively monitor and assess the angle of arrival or changes in the angle of arrival of reflected radar waves RFL as received by receptor 384. The angle of arrival or changes in the angle of arrival allow sensor 376, or a system or component operatively associated with the sensor, to determine the angle or changes in the angle between target 388 and/or 390 and radar source 382 and/or receptor 384. The angle of arrival and/or changes in same can provide information concerning changes in the road surface and/or load shift for vehicle VHC.

FIG. 6 schematically illustrates one example of a sensor 500 in accordance with the subject matter of the present disclosure, such as may be suitable for use as one or more of sensors 126, 268 and 376, for example. As discussed above, sensor 500 is preferably of a type, kind and/or construction that utilizes millimeter wave radar waves having a frequency (f) inclusively in the range of 120 GHz to 240 GHz (120 GHz≤f≤240 GHz) which corresponds to a wavelength (λ) inclusively in the range of 2.5 mm to 1.25 mm (2.5 mm≥λ≥1.25 mm) and that utilizes either a pulsed Doppler radar method or a continuous wave frequency modulation method to generate data, signals, information and/or other communications having a relation to a distance, relative velocity, acceleration, and angle or change in angle between components of an assembly 102, 200, 300 and/or between other components of an associated vehicle or other structure.

Sensor 500 includes a millimeter wave radar source 502 that is operable to emit radar waves having a frequency (f) inclusively in the range of 120 GHz to 240 GHz (120 GHz≤f≤240 GHz) which corresponds respectively to a wavelength (λ) inclusively in the range of 2.5 mm to 1.25 mm (2.5 mm≥λ≥1.25 mm) through a transmit (TX) antenna 504 toward a target surface, such as targets 282, 284, 388, 390 or any other surface. In the illustrated example, radar source 502 includes a frequency modulated continuous wave transmitter 506 operably connected to a band pass filter 508 that passes signals of the frequency generated by transmitter 524 and a power amplifier 510 which, in turn, outputs the emitted radar waves through transmit antenna 504 toward the target.

Sensor 500 also includes a radar wave receptor 512 that is operable to sense, receive, or otherwise detect the returned radar waves reflected from the target through a receive (RX) antenna 514 and also the angle of arrival of the reflected radar waves RFL at receive (RX) antenna 514, which can include an array of multiple antennae. Receive antenna 514 is operably connected to a low noise amplifier 516 which outputs the amplified signal to a band pass filter 518. An RF mixer 520 is operably connected to and received input signals from band pass filter 518 and also the originally generated FMCW signal from frequency modulated continuous wave transmitter 506. Mixer 520 outputs a signal that represents the phase difference between the originally transmitted radar FMCW signal and the reflected signal RFL. RF mixer 520 is operably connected to and outputs the phase difference signal to an analog-to-digital converter (ADC) 522 which outputs the digital signal to a low pass filter 524 for conditioning the signal to remove undesired high-frequency noise. Low-pass filter 524 is operably connected to a Fast Fourier Transform (FFT) module 526 that performs a Fast Fourier Transform on the signal to obtain the desired frequency phase-shift data which are input to a microprocessor or other electronic controller 528, which can alternatively be the controller 122 or another microprocessor or other controller provided as part of vehicle VHC, assembly 102, 200 and/or 300, or provided as part of sensor 500 as illustrated in FIG. 6.

Controller 528 derives the distance, relative velocity, acceleration, and/or the angle or changes in the angle between transmit antenna 504 and the target. Controller 528 can be of any suitable type, kind and/or configuration, such as a microprocessor, for example, for processing data, executing software routines/programs, and other functions relating to at least the determination of the time of flight, frequency phase shift, and angle of arrival or changes in the angle of arrival for the reflected radar waves RFL received by RX antenna 514. Additionally, sensor 500 can be communicatively coupled with other systems and/or components (e.g., controller 122 in FIG. 1) in any suitable wired or wireless manner. For example, sensor 500 can include a wiring harness with one or more leads or conductors 530 that are communicatively coupled with one or more components of the sensor. Additionally, or in the alternative, RF antenna 280 can be used for radio frequency communication between sensor 500 and controller 122 or any other components or systems.

Additionally, controller 528 or other parts of sensor 500 can include a non-transitory storage device or memory 532, which can be of any suitable type, kind and/or configuration that can be used to store data, values, settings, parameters, inputs, software, algorithms, routines, programs and/or other information or content for any associated use or function, such as used in association with the determination of the time of flight and frequency phase shift occurring between the transmitted radar waves and the reflected radar waves received via RX antenna 514, the determination of the angle of arrival of the reflected radar waves RFL at the RX antenna 514, and/or with the performance and/or operation of sensor 500 as well as any systems, components and/or features of the gas spring assemblies and/or suspension system with which the sensor may be operatively associated. Non-transitory memory 532 is operably communicatively coupled with controller 528 such that the controller can access the memory to retrieve and execute any one or more software programs and/or routines. Additionally, data, values, settings, parameters, inputs, software, algorithms, routines, programs and/or other information or content can also be retained within memory 532 for retrieval by controller 528. It will be appreciated that such software routines can be individually executable routines or portions of a software program, such as an operating system, for example. Additionally, it will be appreciated that the controller, processing device and/or memory, can take any suitable form, configuration and/or arrangement, and that the embodiments shown and described herein are merely exemplary. Furthermore, it is to be understood, however, that the modules described above in detail can be implemented in any suitable manner, including, without limitation, software implementations, hardware implementations or any combination thereof. Sensor 500 can also include any other components, circuits, data, values, settings, parameters, inputs, software, algorithms, routines, programs and/or other information or content for operation and use of the displacement and velocity sensor as described herein.

Using such an arrangement, sensor 500 can function as an extremely accurate displacement and velocity sensor that is capable of providing signals, data and/or other information regarding the distance between gas spring end members and/or other components of a vehicle or other structure and the velocity at which such gas spring end members or other components or structures are moving or accelerating or decelerating relative to each other. Advantageously, sensor 500 can accomplish these and other functions from the enclosed environment of the interior of a gas spring assembly (e.g., gas spring assemblies 102, 200 and 304), thereby isolating the sensor from the deleterious effects of environments to which vehicle suspension systems are commonly exposed.

As discussed above, the subject matter of the present disclosure can include an integrated circuit that measures instantaneous, absolute displacement and velocity-based measurements using the time of flight and phase shift of radar waves. Sensors 126, 268, 376 and/or 500 disclosed herein enable an accuracy of +/−1 millimeter to be achieved for displacement measurements, with both velocity and displacement measurements updated with new measurements at an update rate of less than 1 millisecond. In one embodiment, the displacement and velocity measurements are updated with new measurements every 700 microseconds.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus, it is to be distinctly understood claims directed to any such combination of features and/or components, whether or not specifically embodied herein, are intended to find support in the present disclosure. To aid the Patent Office and any readers of this application and any resulting patent in interpreting the claims appended hereto, Applicant does not intend any of the appended claims or any claim elements to invoke 35 U.S.C. 112(f) unless the words “means for” or “step for” are explicitly used in the particular claim.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A gas spring assembly comprising:
a flexible spring member including a flexible wall extending peripherally about a longitudinal axis and axially between opposing first and second ends of said flexible spring member to at least partially define a spring chamber therebetween;
a first end member secured along said first end of said flexible spring member such that a substantially fluid-tight seal is formed therebetween;
a second end member disposed in axially-spaced relation to said first end member, said second end member secured along said second end of said flexible spring member such that a substantially fluid-tight seal is formed therebetween;
a millimeter wave radar source operatively disposed along one of said first and second end members;
a radar receptor supported in a fixed position relative to said millimeter wave radar source;
a target surface located along the other of said first and second end members in axially-spaced relation to said radar source and said radar receptor; and,
a processor communicatively coupled with said radar wave source and said radar wave receptor;
said radar source operable to direct millimeter wave radar waves toward said target surface through at least a portion of said spring chamber such that said radar waves are reflected off said target surface;
said radar receptor operable to generate a signal upon receiving said reflected radar waves reflected off said target surface; and,
said processor operable to determine a displacement distance between said radar source and said target surface based upon at least one of: (i) a time of flight required for said radar waves to travel from said radar source to said target surface and then to said radar receptor; (ii) a frequency phase shift between said radar waves transmitted by said radar source and said radar waves reflected from said target surface and received by said radar receptor.

2. A gas spring assembly according to claim 1, wherein said processor is further operable to determine a relative velocity between said radar source and said target surface based upon a frequency phase shift between said radar waves transmitted by said radar source and said radar waves reflected from said target surface and received by said radar receptor.

3. A gas spring assembly according to either one of claims 1 and 2, wherein said radar source (272; 382; 502) is operative to emit at least one of: (i) individual pulses of radar waves; (ii) a continuous radar wave that is frequency modulated.

4. A gas spring assembly according to claim 1, wherein said radar source emits said millimeter wave radar waves with a frequency greater than or equal to 120 gigahertz (GHz) and a wavelength of less than or equal to 2.5 millimeters (mm) toward said target surface.

5. A gas spring assembly according to claim 1, wherein said processor determines said distance at a resolution of less than or equal to 1 millimeter.

6. A gas spring assembly according to claim 1, wherein said processor determines said distance repeatedly at intervals of less than or equal to 1 millisecond.

7. A gas spring assembly according to claim 1 further comprising a vibration energy harvesting device operable to convert mechanical energy from the movement of said first and second end members toward and away from each other into electrical energy with said vibration energy harvesting device providing electrical power to at least said radar source.

8. A gas spring assembly according to claim 7 further comprising a rechargeable power source operably connected to said radar source to provide electrical power to at least said radar source with said vibration energy harvesting device operably connected to said rechargeable power source to supply recharging electrical power to said rechargeable power source.

9. A gas spring assembly according to claim 1 further comprising a radio frequency charging circuit communicatively coupled with at least said radar source and a radio frequency antenna adapted to receive radio frequency waves, said radio frequency antenna communicatively coupled to said radio frequency charging circuit with said radio frequency charging circuit operable to harvest electrical energy from radio frequency waves received by said radio frequency antenna such that said radio frequency charging circuit is operable to generate electrical power from said received radio frequency waves and supply said electrical power to said radar source.

10. A gas spring assembly according to claim 9 further comprising a rechargeable power source operably connected to said radar source to provide electrical power to said radar source with said radio frequency charging circuit operably connected to said rechargeable power source to supply recharging electrical power to said rechargeable power source.

11. A gas spring assembly according to claim 1, wherein said processor is operable to determine an angle between said target surface and said radar receptor based upon an angle of arrival at which said radar waves reflected from said target surface are received at said radar receptor.

12. A suspension system comprising:
a pressurized gas system including a pressurized gas source and a control device; and,
at least one gas spring assembly according to claim 1 disposed in fluid communication with said pressurized gas source through said control device such that pressurized gas can be selectively transferred into and out of at least said spring chamber.

13. A displacement and velocity sensor comprising:
a millimeter wave radar source and a radar receptor both connected to an associated first vehicle component, said radar source adapted to generate and emit radar waves of a frequency greater than or equal to 120 gigahertz (GHz) and a wavelength of 2.5 millimeters (mm) or less toward an associated target surface provided on an associated second vehicle component that is spaced from and moveable relative to the associated first vehicle component, said radar receptor adapted to receive reflected radar waves reflected from the associated target surface; and,
a processor operably coupled to said radar source and said radar receptor;
said radar receptor operable to generate a signal upon receiving said reflected radar waves; and,
said processor operable to determine both a displacement distance and a relative velocity between said radar source and the associated target surface with said processor operable to determine:
a displacement distance between said radar source and the associated target surface based upon at least one of: (i) a time of flight required for said radar waves to travel from said radar source to the associated target surface and then to said radar receptor; (ii) a frequency phase shift between said radar waves transmitted by said radar source and said radar waves reflected from the associated target surface and received by said radar receptor; and,
relative velocity between said radar source and the associated target surface based upon a frequency phase shift between said radar waves transmitted by said radar source and said radar waves reflected from the associated target surface and received by said radar receptor.

14. A displacement and velocity sensor according to claim 13, wherein said processor is operable to determine an angle between the associated target surface and said radar receptor based upon an angle of arrival at which said radar waves reflected from the associated target surface are received at said radar receptor.

15. A displacement and velocity sensor according to claim 13, wherein said radar source is operative to emit at least one of: (i) individual pulses of radar waves; (ii) a continuous radar wave that is frequency modulated.

16. A gas spring assembly comprising:
a flexible spring member including a flexible wall extending peripherally about a longitudinal axis and axially between opposing first and second ends of said flexible spring member to at least partially define a spring chamber therebetween;
a first end member secured along said first end of said flexible spring member such that a substantially fluid-tight seal is formed therebetween;
a second end member disposed in axially-spaced relation to said first end member, said second end member secured along said second end of said flexible spring member such that a substantially fluid-tight seal is formed therebetween;
a millimeter wave radar source operatively disposed along one of said first and second end members;
a radar receptor supported in a fixed position relative to said millimeter wave radar source;
a target surface located along the other of said first and second end members in axially-spaced relation to said radar source and said radar receptor; and,
a processor communicatively coupled with said radar wave source and said radar wave receptor; and,
said radar source operable to direct millimeter wave radar waves toward said target surface through at least a portion of said spring chamber such that said radar waves are reflected off said target surface;
said radar receptor operable to generate a signal upon receiving said reflected radar waves reflected off said target surface; and,
said processor operable to determine:
a displacement distance between said radar source and said target surface based upon at least one of: (i) a time of flight required for said radar waves to travel from said radar source to said target surface and then to said radar receptor; (ii) a frequency phase shift between said radar waves transmitted by said radar source and said radar waves reflected from said target surface and received by said radar receptor;
a relative velocity between said radar source and said target surface based upon a frequency phase shift between said radar waves transmitted by said radar source and said radar waves reflected from said target surface and received by said radar receptor; and,
an angle between said target surface and said radar receptor based upon an angle of arrival at which said radar waves reflected from said target surface are received at said radar receptor.

17. A gas spring assembly according to claim 16 further comprising a radio frequency charging circuit communicatively coupled with at least said radar source and a radio frequency antenna adapted to receive radio frequency waves, said radio frequency antenna communicatively coupled to said radio frequency charging circuit such that said radio frequency charging circuit is operable to harvest electrical energy from radio frequency waves received by said radio frequency antenna with said radio frequency charging circuit operable to generate electrical power from said received radio frequency waves and supply said electrical power to at least said radar source.

18. A gas spring assembly according to claim 16 a vibration energy harvesting device operable to convert mechanical energy from the movement of at least one of said first and second end members into electrical energy with said vibration energy harvesting device providing electrical power to at least said radar source.

19. A gas spring assembly according to claim 16 further comprising a rechargeable power source communicatively coupled with at least said radar source and operable to provide electrical power thereto.

20. A gas spring assembly according to claim 16, wherein said radar source is operative to emit at least one of: (i) individual pulses of radar waves; (ii) a continuous radar wave that is frequency modulated.
